(19) United States
(12) Patent Application Publication
(10) Pub. No.: US 2026/0294114 A1
(43) Pub. Date: Oct. 1, 2026

(54) CHAIR WITH SNAP-FIT ASSEMBLY

(71) Applicant: ATEC INTERNATIONAL TEAM CO., LTD., Taoyuan City (TW)

(72) Inventor: Te-Chun Chen, Taoyuan City (TW)

(21) Appl. No.: 19/187,802

(22) Filed: Apr. 23, 2025

(30) Foreign Application Priority Data
Mar. 26, 2025 (TW) 114111471

(51) Int. Cl. A47C 4/03; F16B 12/20; F16B 12/26

(52) U.S. Cl. CPC A47C 4/03; F16B 12/2009; F16B 12/26; F16B 2200/83

(57) ABSTRACT

A chair designed for quick, intuitive, and tool-free assembly includes a seat cushion, a seat plate, and a seat back frame. The seat plate supports the seat cushion and is provided with multiple seat plate fasteners configured to engage with corresponding seat back frame fasteners located on the seat back frame. At least one pair of corresponding fasteners utilizes a snap-fit mechanism that generates audible feedback upon secure assembly, thereby clearly indicating that locking is complete. Additionally, certain fastener pairs incorporate pivotal connections, allowing the seat plate to rotate relative to the seat back frame, facilitating convenient assembly. The chair further includes a magnetic engagement mechanism designed to secure the seat plate in an upwardly rotated position, providing a stable yet easily detachable assembly. The chair components are preferably plastic and manufactured via injection molding, ensuring an efficient, tool-free assembly structure, making it particularly suitable for DIY assembly.

### FIELD OF THE DISCLOSURE

The present invention relates to a chair, and more particularly, to a chair that can be assembled and disassembled without tools. The chair features snap-fit fasteners that provide audible feedback upon secure assembly and incorporates pivotal connections and magnetic components to enhance ease of use and transportation.

### BACKGROUND OF THE INVENTION

Chairs that can be assembled by end users are becoming increasingly popular in various markets, particularly in the home and office furniture sectors. Traditional chair designs often require screws, bolts, and tools such as screwdrivers or hex keys to ensure secure assembly. While these conventional assembly methods offer reliability, they also present several drawbacks. These include lengthy assembly times, complex assembly procedures, and the risk of improper assembly, which may compromise the functionality of the chair. These issues are especially pronounced in the growing do-it-yourself (DIY) furniture market, where consumers prefer products that allow for quick and intuitive assembly.

Furthermore, conventional screw-based and other hardware-dependent assembly methods contribute to higher production costs. These costs arise from labor-intensive manufacturing processes, additional expenses associated with packaging multiple components, and increased shipping costs due to the larger packaging volume required when chairs are transported in a fully assembled state.

Accordingly, there is a clear market demand for an improved chair design that provides a reliable tool-free assembly mechanism, an intuitive locking confirmation system, ease of repositioning or storage, and a durable structure that can withstand repeated assembly and disassembly without significant wear or deformation.

### SUMMARY OF THE INVENTION

The present invention provides an improved chair that overcomes the disadvantages of conventional chairs. The chair is designed for quick and intuitive tool-free assembly and utilizes specially designed snap-fit fasteners and magnetic engagement components to enhance ease of use and assembly efficiency.

In one aspect, the present invention provides a chair comprising a seat cushion, a seat plate, and a seat back frame. The seat plate is configured to support the seat cushion and includes multiple seat plate fasteners, while the seat back frame includes corresponding seat back frame fasteners. The seat plate is assembled to the seat back frame via a snap-fit mechanism, eliminating the need for tools and significantly simplifying the assembly process.

In another aspect, the present invention includes a snap-fit mechanism that generates an audible feedback signal upon secure engagement. At least one pair of fasteners includes an inverted U-shaped fastener disposed on the seat plate, which engages with a corresponding fastener on the seat back frame. The corresponding fastener includes vertical and horizontal protrusions. During assembly, the inverted U-shaped fastener temporarily deforms upon interference with the vertical protrusion, then rebounds downward upon passing over the vertical protrusion and strikes the horizontal protrusion, producing an audible sound to confirm secure locking.

Additionally, the present invention includes a pivotal connection mechanism, wherein the pivotal connection is positioned at the lateral sides of the seat plate and the seat back frame, allowing the seat plate to rotate relative to the seat back frame. This configuration provides controlled rotation and precise alignment during assembly.

The present invention further provides a magnetic engagement mechanism that maintains the seat plate in an upwardly rotated position relative to the seat back frame. The magnetic engagement mechanism securely holds the seat plate in place, yet still allows the user to manually disengage it with ease. This feature significantly enhances convenience and functionality, particularly for storage and transportation applications.

In another embodiment, the seat plate and the seat back frame are manufactured as plastic components using an injection molding process. This manufacturing method provides the necessary material flexibility for the snap-fit fasteners while ensuring structural durability and lightweight characteristics, making the chair more suitable for transportation and handling.

Accordingly, the present invention provides a user-friendly, reliable, and efficient chair assembly solution that enhances ease of use and reduces the challenges commonly encountered in the assembly of traditional chairs.

To make the above features and advantages of the present invention more apparent and understandable, a preferred embodiment is exemplified below, in conjunction with the accompanying drawings, for detailed description.

### BRIEF DESCRIPTION OF THE DRAWINGS

FIG. 1 is a perspective view of a chair according to an embodiment of the present invention.

FIG. 2A is a perspective view of the underside of the seat plate of the chair.

FIG. 2B is an enlarged partial perspective view of the fasteners on the underside of the seat plate, as shown in FIG. 2A.

FIG. 2C is a perspective view of the upper surface of the seat plate, showing the side that contacts the seat cushion.

FIG. 2D is an enlarged partial perspective view of a portion of the seat plate, as shown in FIG. 2C.

FIG. 3A is a perspective view of the seat back frame of the embodiment, illustrating the arrangement of the corresponding fasteners.

FIG. 3B is an enlarged partial perspective view of the seat back frame, as shown in FIG. 3A, clearly showing the protrusions on the central fastener.

FIG. 4 is a side view showing the pivotal connection and magnetic engagement mechanism between the seat plate and the seat back frame when the seat plate is rotated upward relative to the seat back frame.

### DESCRIPTION OF THE PREFERRED EMBODIMENTS

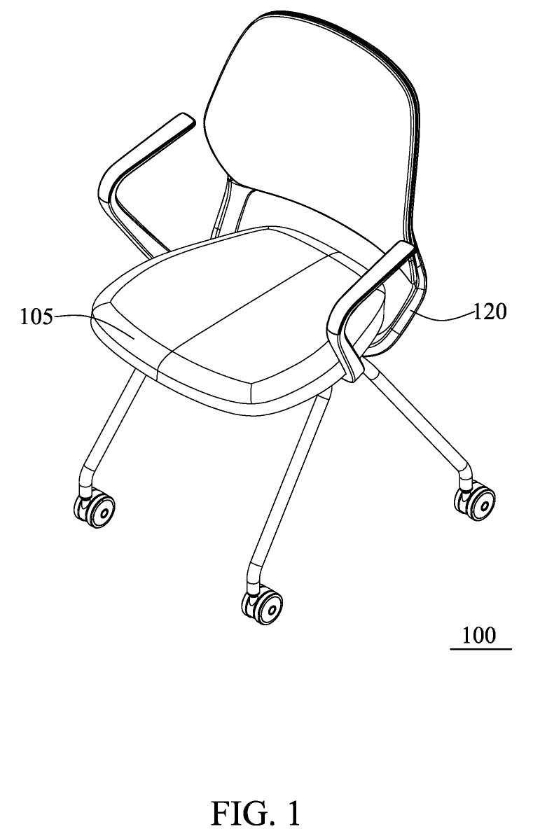

Reference is made to FIG. 1, which illustrates an embodiment of a chair 100 according to the present invention. The chair 100 generally includes a seat cushion 105, a seat plate 110, and a seat back frame 120. The seat plate 110 is configured to support the seat cushion 105, while the seat back frame 120 provides back support. The seat cushion 105 is typically made of a soft or semi-soft material, such as foam, and is covered with fabric, leather, or another suitable material to provide comfort and aesthetic appeal.

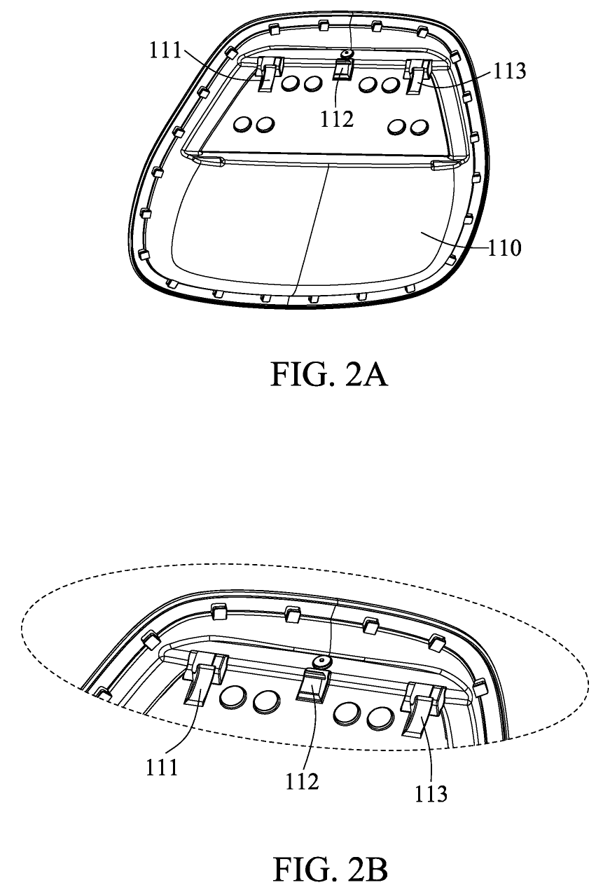

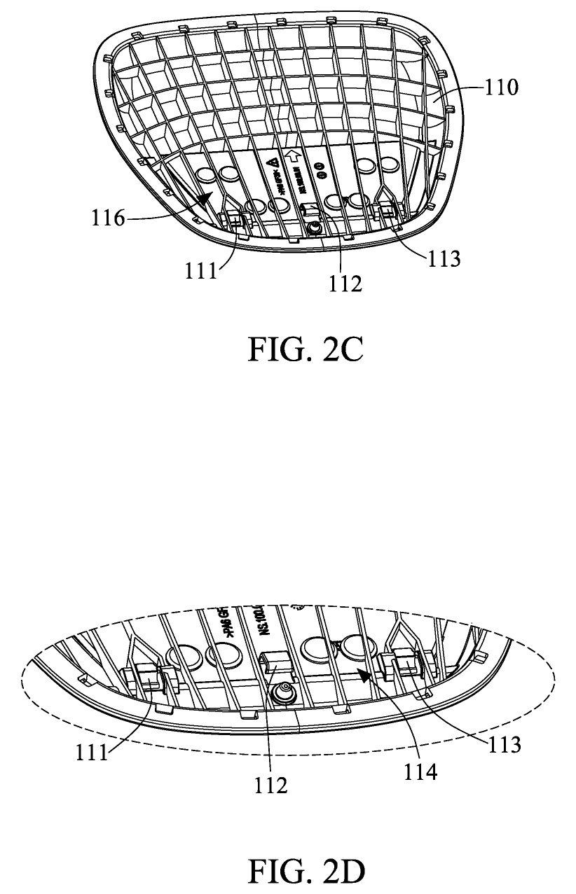

Reference is made to FIGS. 2A-2D, which show the structure of the seat plate 110. The seat plate 110 includes an upper surface 116 (shown in FIG. 2C) and a lower surface 114 (shown in FIG. 2A). The upper surface 116 faces and directly supports the seat cushion 105, while the lower surface 114 faces away from the seat cushion and incorporates structural features designed for assembly with the seat back frame 120. In this embodiment, the seat plate 110 is made of plastic material and is manufactured using an injection molding process. This ensures durability, lightweight construction, and the necessary flexibility for the snap-fit mechanism, which will be described later.

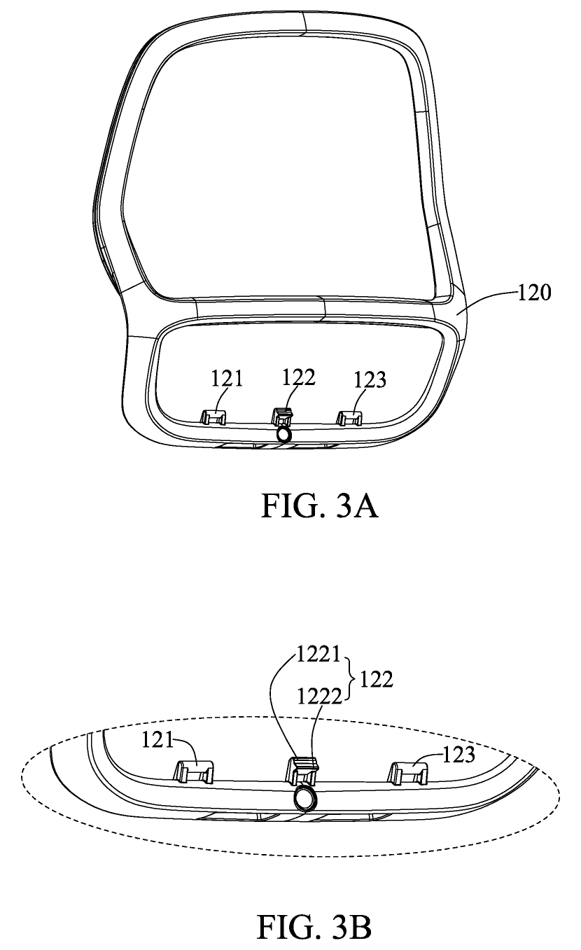

Reference is made to FIGS. 3A and 3B, which illustrate the seat back frame 120. The seat back frame 120 provides back support for the user and is generally made of a sturdy plastic material. In this embodiment, it is also manufactured using an injection molding process. The seat back frame 120 includes multiple fasteners (described later), which are designed to directly engage with the corresponding fasteners on the seat plate 110, thereby enabling a tool-free assembly process.

The description of the above structure provides the foundation for further explanation of the unique fastener mechanism and assembly method of the present invention. The following sections describe its design and operational principles in greater detail.

Particular reference is made to FIGS. 2A-2D and 3A-3B, which illustrate an innovative tool-free assembly mechanism of the chair 100. This mechanism utilizes specially designed snap-fit fasteners to enable quick assembly without the need for tools. As shown in the figures, the seat plate 110 is provided with multiple seat plate fasteners, which are strategically positioned to engage with corresponding seat back frame fasteners on the seat back frame 120.

In this embodiment, the seat plate fasteners mounted on the seat plate 110 include at least three fasteners: two lateral seat plate fasteners 111 and 113 and a central seat plate fastener 112. Correspondingly, the seat back frame 120 includes matching fasteners: two lateral seat back frame fasteners 121 and 123 and a central seat back frame fastener 122. The two lateral seat plate fasteners 111 and 113 are identical to each other, and the two lateral seat back frame fasteners 121 and 123 are likewise identical to each other.

As shown in FIGS. 2B and 3B, the central seat plate fastener 112 has an inverted U-shaped structure, which functions as an elastic clip and is designed to engage with the central seat back frame fastener 122. In this embodiment, the central seat back frame fastener 122 includes two protrusions: a first protrusion 1221 extending in a vertical direction and a second protrusion 1222 extending in a horizontal direction.

During assembly, the inverted U-shaped central seat plate fastener 112 initially comes into contact with the vertically extending first protrusion 1221. This initial contact causes the fastener 112 to elastically deform due to interference, bending upward. As the fastener 112 passes over the vertical protrusion 1221, it suddenly rebounds downward, striking the horizontal protrusion 1222. This snap-fit action generates an audible feedback signal, indicating to the assembler that the seat plate 110 and the seat back frame 120 have been successfully and securely assembled.

This intuitive snap-fit design significantly reduces the complexity and time required for assembly compared to conventional screw-based furniture assembly methods. Additionally, the audible snap-fit mechanism enhances user convenience and provides confidence in the structural integrity and stability of the assembled chair.

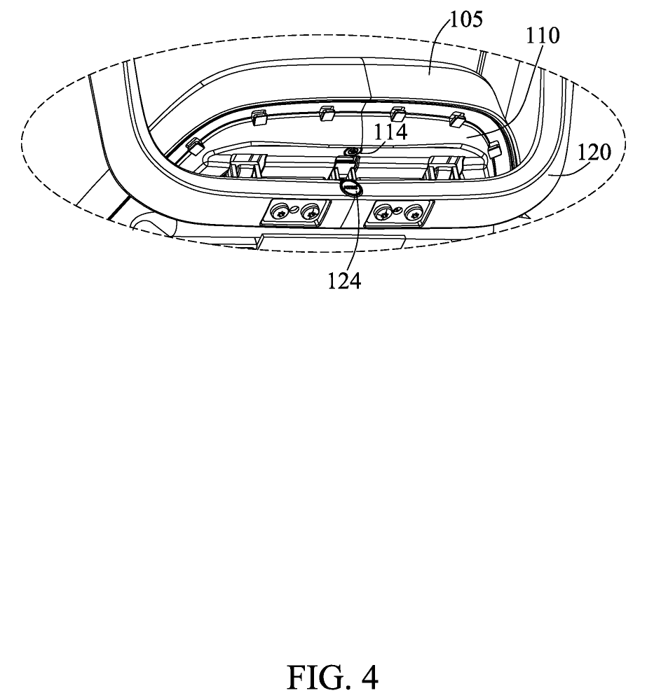

Particular reference is now made to FIGS. 1 and 4, which illustrate another important feature of the present invention: the pivotal connection and magnetic engagement mechanism between the seat plate 110 and the seat back frame 120. The lateral seat plate fasteners 111, 113 and their corresponding lateral seat back frame fasteners 121, 123 are designed to form a pivotal connection. This pivotal connection allows the seat plate 110 to rotate relative to the seat back frame 120, facilitating operation, storage, and transportation of the chair 100.

In this embodiment, the lateral seat plate fasteners 111, 113 and the lateral seat back frame fasteners 121, 123, which form the pivotal connection, are symmetrically arranged on the sides of the seat plate 110 and the seat back frame 120. This configuration ensures stable rotation and precise alignment during assembly and disassembly.

Additionally, as shown in FIG. 4, the present invention includes a magnetic engagement mechanism. The magnetic engagement mechanism includes a magnetic element 114, which, in this embodiment, is disposed on the seat plate 110 and engages with a corresponding magnetic element 124 disposed on the seat back frame 120. When the seat plate 110 is rotated upward relative to the seat back frame 120, the magnetic element 114 magnetically engages with the corresponding magnetic element 124, thereby securing the seat plate 110 in an upwardly rotated position.

In other embodiments, the magnetic element 114 may alternatively be positioned on the seat back frame 120, and the corresponding magnetic element 124 may be replaced with a metal element capable of being attracted by a magnet.

Furthermore, the magnetic engagement mechanism is specially designed to provide sufficient magnetic attraction, ensuring that the seat plate 110 remains securely held in the desired position while still allowing the user to manually release the seat plate 110 with ease when needed. This functionality significantly enhances user convenience, enabling the user to effortlessly rotate the seat plate to an appropriate seating position or fold it upward for efficient storage or transport.

The combination of the pivotal connection and the magnetic engagement mechanism ensures both the reliability and flexibility of the chair, further improving its usability and practicality.

In summary, the chair described in the embodiments significantly enhances assembly convenience and efficiency through its innovative snap-fit fasteners. These snap-fit fasteners provide an intuitive and audible feedback mechanism, confirming secure assembly. Additionally, the integration of the pivotal connection and the magnetic engagement mechanism further enhances user convenience, allowing the chair to be easily adjusted, folded, stored, and transported.

By eliminating the need for traditional screws, bolts, and other fasteners, the present invention substantially simplifies the assembly process, making it particularly well-suited for DIY assembly by consumers or as a cost-effective assembly solution for retailers following product delivery. This innovative assembly method not only improves user experience but also effectively reduces transportation and storage costs due to its compact and partially disassembled state.

Moreover, the chair described in the embodiments is constructed using resilient materials, such as injection-molded plastic, ensuring high structural strength, durability, and flexibility. The chair is designed to withstand multiple assembly and disassembly cycles without experiencing significant wear or deformation. The adaptability of this design also allows for further customization and modifications to accommodate various user needs and market demands.

Accordingly, the chair described in the embodiments introduces a significant technological advancement in furniture design, providing practical benefits to manufacturers, retailers, and end users alike. It successfully meets the long-standing industry demand for user-friendly, durable, and cost-effective seating solutions.

Beyond the described embodiments, the present invention also contemplates various alternative structures, modifications, and variations, all of which should be considered within the scope of the present invention.

For example, the specific geometric shapes and dimensions of the fasteners, protrusions, and magnetic elements described herein may be adjusted based on manufacturing requirements, desired assembly force, or aesthetic considerations. Furthermore, while the preferred manufacturing method for the present invention is plastic injection molding due to its excellent flexibility, lightweight properties, and cost efficiency, other materials and processes may also be used. Alternative manufacturing methods, such as die casting, extrusion molding, or 3D printing, may be employed either as substitutes or as complementary techniques to achieve different functional requirements or design objectives.

Additionally, while the present invention primarily describes the use of a permanent magnet as the magnetic engagement mechanism, other magnetic systems, such as electromagnets or combinations thereof, may also be utilized. These alternatives may be implemented to provide adjustable magnetic attraction based on user preferences or operational conditions.

The present invention also encompasses various potential modifications, including the integration of additional ergonomic or aesthetic features into the seat cushion, seat plate, or seat back frame. Examples of such modifications include, but are not limited to, the incorporation of lumbar support structures, cushioning elements with different densities or hardness levels, and surface treatments or coatings designed to enhance appearance or comfort.

Although the invention has been described with reference to specific embodiments, such embodiments are illustrative only and not limiting. It will be understood by those skilled in the art that various modifications, additions, and substitutions are possible without departing from the spirit and scope of the invention as defined by the appended claims. Accordingly, the legal scope of the invention is defined solely by the claims and their equivalents, and not by the foregoing description.

1. A chair, comprising:
a seat cushion;
a seat plate configured to support the seat cushion and including a plurality of seat plate fasteners; and
a seat back frame including a plurality of seat back frame fasteners corresponding to the seat plate fasteners, the seat back frame fasteners being configured to engage with the seat plate fasteners;
wherein the seat plate is detachably assembled to the seat back frame via engagement between the seat plate fasteners and the seat back frame fasteners.

2. The chair of claim 1, wherein the seat plate fasteners comprise a central seat plate fastener and two lateral seat plate fasteners, and the seat back frame fasteners comprise two lateral seat back frame fasteners and a central seat back frame fastener;
wherein the central seat plate fastener corresponds to the central seat back frame fastener, and the lateral seat plate fasteners correspond to the lateral seat back frame fasteners; and
wherein the seat plate fasteners and the seat back frame fasteners include a snap-fit mechanism that generates an audible sound to indicate secure locking.

3. The chair of claim 2, wherein the snap-fit mechanism comprises the central seat plate fastener and the central seat back frame fastener, the central seat plate fastener being an inverted U-shaped fastener, and the corresponding central seat back frame fastener including at least one protrusion that interferes with the inverted U-shaped fastener during assembly.

4. The chair of claim 3, wherein the central seat back frame fastener comprises:
a first protrusion extending in a vertical direction; and
a second protrusion extending in a horizontal direction;
wherein, during assembly, the inverted U-shaped fastener initially contacts and temporarily deforms upward due to interference with the first protrusion, then rebounds downward after passing over the first protrusion, striking the second protrusion and producing an audible sound to indicate secure locking.

5. The chair of claim 1, wherein at least two pairs of corresponding seat plate fasteners and seat back frame fasteners are pivotally connected, allowing the seat plate to rotate relative to the seat back frame.

6. The chair of claim 5, wherein the pivotal connection between the seat plate and the seat back frame is provided at lateral sides thereof to ensure stable rotation and accurate alignment during assembly.

7. The chair of claim 5, further comprising:
a magnetic element disposed on at least one of the seat plate or the seat back frame; and
a corresponding magnetic element or a metal element configured to magnetically engage with the magnetic element and disposed on the other of the seat plate or the seat back frame;
wherein the magnetic element and the corresponding magnetic element or metal element attract each other to maintain the seat plate in an upwardly rotated position relative to the seat back frame.

8. The chair of claim 7, wherein the magnetic element provides sufficient magnetic force to securely hold the seat plate in the upwardly rotated position while allowing a user to manually disengage it with ease.

9. The chair of claim 1, wherein the seat plate and the seat back frame are plastic components manufactured by injection molding.
